(19) United States
(12) Patent Application Publication
(10) Pub. No.: US 2016/0004092 A1
(43) Pub. Date: Jan. 7, 2016

(54) Collapsible Eyewear

(71) Applicant: Ron Lando, Corte Madera, CA (US)

(72) Inventor: Ron Lando, Corte Madera, CA (US)

(21) Appl. No.: 14/323,979

(22) Filed: Jul. 3, 2014

(51) Int. Cl. G02C 5/00

(52) U.S. Cl. CPC G02C 5/006

(57) ABSTRACT

Eyewear and method for its storage. The eyewear includes a pair of lenses, temple pieces and a strap as well as a pair of releasable connectors connected to respective inner ends of the lenses. Each temple piece has a first segment and a second segment, each first segment having a first end and a second end, each first end being pivotally connected to a lens, each second segment having a first end and a second end, the first end of each second segment being pivotally connected to a second end of a first segment and the second end of each of the second segment being captured by a strap, the strap being composed of thermoplastic polyester elastomer which is both flexible and shape retentive.

### TECHNICAL FIELD

The present invention deals with eyewear having a snap-together bridge feature and which is collapsible for enhanced storage and portability.

### BACKGROUND OF THE INVENTION

Applicant is the owner of U.S. Pat. Nos. 6,253,388 and 7,931,366. The invention disclosed and claimed in the '388 patent involved eyewear comprised of a pair of lenses, releasable connectors connecting the respective inner ends of the lenses, a pair of temple pieces pivotable with respect to outer ends of the lenses and a rigid strap attached to rear ends of the temple pieces including an arc-shaped base bridging the parallel legs. The strap was taught to be positioned below the lenses so as not to interfere with, for example, the hairdo of a user. The inner ends of the lenses were taught to be releasably secured to each other by connectors, preferably, by magnets. To position the eyewear, the lenses are first separated from each other and pivoted outwardly. The strap is then wrapped around the back of the user's head and the lenses pivoted toward each other and secured together in the front of the user's eyes. The lenses were taught to be instantly separable to facilitate putting on and taking off the eyewear and instantly connectable for a secure and accurate fit. The disclosure of the '388 patent is hereby incorporated by reference herein.

Applicant's U.S. Pat. No. 7,931,366 represents an improvement over the '388 patent by calling for a telescoping segment located within the arc-shaped base of the eyewear's strap to selectively alter the length of the arc-shaped base for modifying the spacing between the substantially parallel legs of the rigid strap to adjust the strap to varying widths of a user's head. Although doing so greatly expanded the flexibility of applicant's eyewear enabling it to be accommodated by users of different head sizes, it was determined by applicant that its eyewear could benefit yet further by additional modification.

Because the relatively rigid strap is fixed to the eyewear's temple pieces, even if the lenses were to be separated from each other through the eyewear's releasable connector, the substantially U-shaped strap prevents the eyewear from collapsing compactly. As such, where traditional eyewear can be placed, for example, in the vest pocket of a user by simply pivoting temple pieces against the lenses or their frames when not in use, the eyewear made the subject of the '388 and '366 patents are either worn, hung from a user's neck or placed upon a desk or other surface. Applicant's prior eyewear simply could not be conveniently stored.

It is thus an object of the present invention to provide eyewear having a snap-together bridge feature which is collapsible for enhanced storage and portability.

This and further objects will become more readily apparent when considering the following disclosure and appended claims.

### SUMMARY OF THE INVENTION

Eyewear comprising a pair of lenses, temple pieces and a strap, a pair of releasable connectors connected to respective inner ends of said lenses, a pair of temple pieces, each temple piece having a first segment and a second segment, each of said first segment having a first end and a second end, each first end being pivotally connected to a lens, each second segment having a first end and a second end, said first end of each second segment being pivotally connected to a second end of said first segment and said second end of each of said second segment being captured by said strap, said strap comprising a flexible and shape retentive band of thermoplastic polyester elastomer.

A method of storing eyewear in a compact orientation, said eyewear comprising a pair of lenses, temple pieces and a strap, a pair of releasable connectors connected to respective inner ends of said lenses, a pair of temple pieces, each temple piece having a first segment and a second segment, each of said first segment having a first end and a second end, each first end being pivotally connected to a lens, each second segment having a first end and a second end, said first end of each second segment being pivotally connected to a second end of said first segment and said second end of each of said second segment being captured by said strap, said strap comprising a flexible and shape retentive band of thermoplastic polyester elastomer wherein said method comprises separating said lenses by separating said releasable connectors, pivoting said lenses at said first ends of said first temple pieces such that said lenses are positioned against said first temple pieces, rotating said second temple pieces with respect to the second ends of said first temple pieces by positioning said first and second temple pieces substantially adjacent to one another and folding said strap upon itself after which said eyewear is configured for storage.

A method of storing eyewear in a compact orientation, said eyewear comprising a pair of lenses, temple pieces and a strap, a pair of releasable connectors connected to respective inner ends of said lenses, a pair of temple pieces, each temple piece having a first segment and a second segment, each of said first segment having a first end and a second end, each first end being pivotally connected to a lens, each second segment having a first end and a second end, said first end of each second segment being pivotally connected to a second end of said first segment and said second end of each of said second segment being captured by said strap, said strap comprising a flexible and shape retentive band of thermoplastic polyester elastomer wherein said method comprises separating said lenses by separating said releasable connectors, pivoting said lenses at said first ends of said first temple pieces such that said lenses are positioned against said first temple pieces, rotating said second temple pieces with respect to the second ends of said first temple pieces by positioning said first and second temple pieces substantially adjacent to one another and folding said strap upon itself, providing a storage container and fitting said eyewear therein.

### BRIEF DESCRIPTION OF THE FIGURES

FIG. 1 is a perspective view of the eyewear of the present invention.

FIG. 2A is a top view of the eyewear of the present invention in its semi-collapsed state.

FIG. 2B is a top view of the eyewear of the present invention showing its further manipulation carried out during the process of its collapse.

FIG. 3 is a side plan view of the eyewear of the present invention in its fully collapsed state being introduced to a case for storage.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

As noted previously, applicant has taught, in its U.S. Pat. No. 6,253,388, eyewear which includes lens 10 optionally mounted in respective frames 14. Connectors 11 are preferably attached to the inner ends of frames 14 or to the lenses themselves if the frames are eliminated. Temples 12 are preferably telescoping for fitting different wearers. Without this feature, an attempt to wear applicant's eyewear with its snap-together bridge feature could, and oftentimes does, inadvertently lose connection at the bridge resulting in lens separation.

As further noted in applicant's '388 patent, a strap is connected to one of the eyewear's temple pieces which extends therefrom, progressively to a downward segment and connecting to an opposite segment and temple piece through the use of a U-shaped base. Lenses directly or through the eyewear's frames releasably connect to one another at the bridge of a user's nose generally through the employment of magnets as further discussed in the '388 patent.

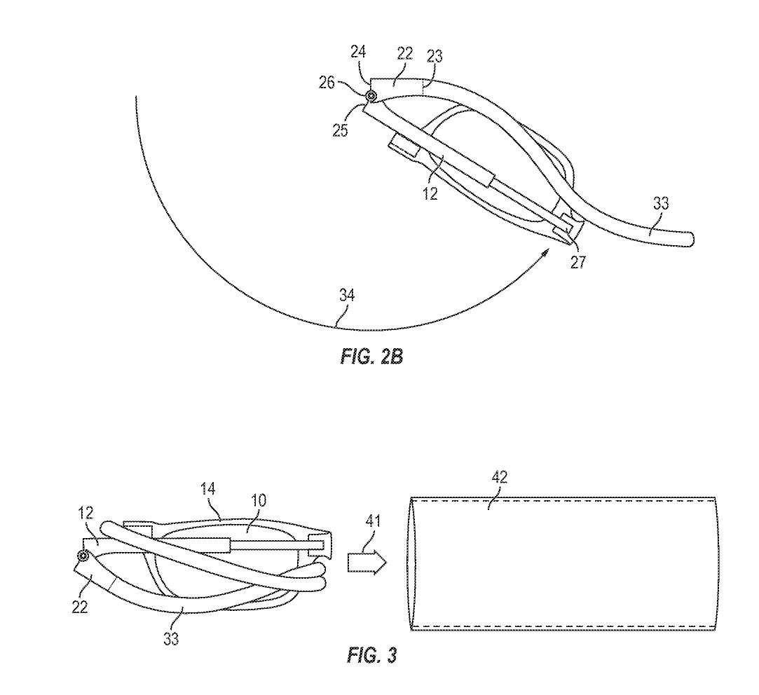

Although applicant's previous eyewear with its unique snap-together bridge feature represented a significant advancement in the art, this product was not without its limitations. Significant among them resulted from the use of a strap which was rigid. The strap was to maintain the eyewear properly positioned with its lenses in front of the user's eyes. However, when a user did not require the employment of this eyewear, it simply hung from a user's neck with its lenses 10 optionally pivoted about a hinge such as depicted schematically by arrows 31 of FIG. 2A. However, if the user wished to completely remove the eyewear and storage it, its rigid strap would prevent the eyewear from compactly fitting within a case or storage receptacle.

Recognizing this limitation, applicant has made significant modifications to its previously invented eyewear focusing upon the synergistic interaction between the temple pieces, releasable connectors and strap to enable the present eyewear to be stored in a compact orientation.

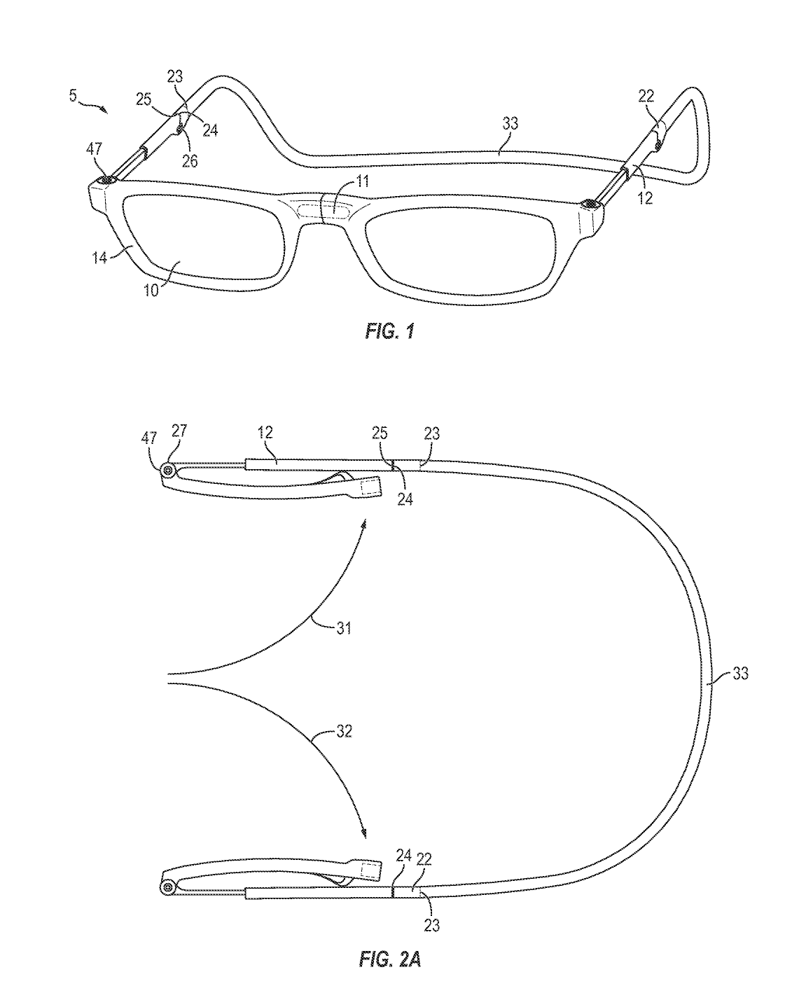

Turning first to FIG. 1, eyewear 5 is shown comprising a pair of lenses 10, a pair of releasable connectors generally in the form of magnets 11 positioned on the inner ends of the lenses or the inner ends of frame 14. Unlike the eyewear of the '388 patent, strap 33 comprises a flexible band composed of a thermoplastic polyester elastomer. This is a class of copolymers resulting from the combination of polymeric plastic and rubber and exhibits both thermoplastic and elastomeric properties. Such material is flexible enough to bend without deforming but is memory retentive enabling strap 33 to return to its original shape even if eyewear 5 has been stored for a protracted period of time. Thus, unlike prior eyewear of this type, strap 33 can be folded upon itself or wrapped about frame 14 producing a compact structure best illustrated in reference to FIG. 3.

To further enhance the compact storage capabilities of the present invention, eyewear 5 is provided with temple pieces that have also been significantly modified. Specifically, the temple pieces have now been segmented, each side of the eyewear having two such temple segments separated by hinge 26. More specifically, each temple piece is composed of first segment 12 and second segment 22, said first segment having a first end 27 and second end 25, each first end 27 being pivotally connected to a lens 10 or frame 14 at hinge 47. Each second segment 22 is also provided with first end 24 and second end 23, the first end 24 of each second segment 22 is pivotally connected to second end 25 of first segment 12 at hinge 26.

As noted, strap 33 captures second end 23 of second segment 22 such that as first segment 12 rotates in the direction of arrow 34 about pivot 26, strap 33 nests as shown in FIG. 2B. More specifically, in preparing eyewear 5 for storage, a user would first separate lenses 10 by releasing connectors 11. Lenses 10, alone or together with frames 14 are rotated along pivots 47 in the direction of arrows 31 and 32 such that lenses 10 are positioned against first temple pieces 12, again, as best illustrated in FIG. 2A. Thereupon, temple segments 22 are rotated at their first ends 24 with respect to second ends 25 of temple segments 12 as shown schematically by arrow 34 of FIG. 2B such that first and second temple segments 12 and 22, respectively, extend substantially adjacent to one another as best depicted in FIG. 2B and FIG. 3. In addition, strap 33 can be folded upon itself or wrapped about lenses 10 or frame 14 for insertion within compact storage container 42 again as best depicted in FIG. 3. Without the combination of a thermoplastic polyester elastomer band which is flexible yet shape retentive and hinge 26 enabling temple segments 12 and 22 to rotate from substantially linear to substantially adjacent orientations, fitting eyewear 5 into compact storage container 42 would be impossible.

The present invention provides improved eyewear having clear advantages over the prior art. Oftentimes, such eyewear is intended to be used as reading glasses which are used only intermittently. Prior eyewear of this type is either worn over the bridge of one's nose or hung from a user's neck. The present eyewear now has the additional flexibility of being able to be compactly stored when not in use.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

1. Eyewear comprising a pair of lenses, temple pieces and a strap, a pair of releasable connectors connected to respective inner ends of said tenses, a pair of temple pieces, each temple piece having a first segment and a second segment, each of said first segment having a first end and a second end, each first end being pivotally connected to a lens, each second segment having a first end and a second end, said first end of each second segment being pivotally connected to a second end of said first segment and. said second end of each of said second segment being captured by said strap, said strap comprising a flexible and shape retentive band of thermoplastic polyester elastomer.

2. A method of storing eyewear in a compact, orientation, said eyewear comprising a pair of lenses, temple pieces and a strap, a pair of releasable connectors connected to respective inner ends of said lenses, a pair of temple pieces, each temple piece having a first segment and a second segment, each of said first segment having a first end and a second end, each first end being pivotally connected to a lens, each second segment having a first end and a second end, said first end of each second segment being pivotally connected to a second end of said first segment and said second end of each of said second segment being captured by said strap, said strap comprising a flexible and shape retentive band of thermoplastic polyester elastomer wherein said method comprises separating said lenses by separating said releasable connectors, pivoting said lenses at said first ends of said first temple pieces such that said lenses are positioned against said first temple pieces, rotating said second temple pieces with respect to the second ends of said first temple pieces by positioning said first and second temple pieces substantially adjacent to one another and folding said strap upon itself after winch said eyewear is configured for storage.

3. A method of storing eyewear in a compact orientation, said eyewear comprising a pair of lenses, temple pieces and a strap, a pair of releasable connectors connected to respective inner ends of said lenses, a pair of temple pieces, each temple piece having a first segment and a second segment, each of said first segment having a first end and a second end, each first end being pivotally connected to a lens, each second segment having a first end and a second end, said first end of each second segment being pivotally connected to a second end of said first segment and said second end of each of said second segment being captured by said strap, said strap comprising a flexible and shape retentive band of thermoplastic polyester elastomer wherein said method comprises separating said lenses by separating said releasable connectors, pivoting said lenses at said first ends of said first temple pieces such that said lenses are positioned against said first temple pieces, rotating said second temple pieces with respect to the second ends of said first temple pieces by positioning said first and second temple pieces substantially adjacent to one another and folding said strap upon itself, providing a storage container and titling said eyewear therein.

4. The eyewear of claim 1 wherein said releasable connectors comprise magnets.

5. The method of claim 2 wherein said releasable connectors comprise magnets.

6. The method of claim 3 wherein said releasable connectors comprise magnets.
